(19) United States
(12) Patent Application Publication
(10) Pub. No.: US 2019/0106309 A1
(43) Pub. Date: Apr. 11, 2019

(54) Shield Assembly For Basket Of Aerial Work Platform

(71) Applicant: MCF Distributing, LLC, Mill Creek, WA (US)

(72) Inventor: Mark S. Mueller, SeaTac, WA (US)

(73) Assignee: MCF Distributing, LLC, Mill Creek, WA (US)

(21) Appl. No.: 16/151,056

(22) Filed: Oct. 3, 2018

Related U.S. Application Data
(60) Provisional application No. 62/568,494, filed on Oct. 5, 2017.

(51) Int. Cl. B66F 11/04; B66F 13/00

(52) U.S. Cl. CPC B66F 11/044; B66F 13/00

(57) ABSTRACT

Disclosed embodiments include shield assemblies for baskets of aerial work platforms, methods of fabricating a shield assembly for a basket of an aerial work platform, and methods of attaching a shield assembly onto a basket of an aerial work platform. In an illustrative embodiment given by way of non-limiting example, a shield assembly for a basket of an aerial work platform includes a flexible cover configured to be disposed contiguously about interior sides of a basket of an aerial work platform. Attachment devices are attached to the flexible cover and are configured to removably attach the flexible cover to a basket of an aerial work platform. Tensioning members are removably attachable to a bottom portion of the flexible cover.

### TECHNICAL FIELD

The present disclosure relates to accessories for aerial work platforms.

### BACKGROUND

An aerial work platform is a mechanical device used to provide temporary access for people or equipment to inaccessible areas, usually at height. Aerial work platforms are generally used for temporary, flexible access purposes such as maintenance and construction work, such as among other things performing planned maintenance items, performing repairs, painting, cleaning, and the like.

One type of aerial work platform is known as a boom lift (sometimes referred to as a “cherry picker”). A boom lift includes a mobile base unit with a boom extending therefrom. The boom may have any number of sections as desired. The sections may be articulating or telescoping.

A basket is attached to the end of the boom. In a typical boom lift, a mounting bracket is attached to the end of the boom. A vertical member extends vertically downwardly from the mounting bracket. Horizontal members (such as forks) extend horizontally from the vertical member. The basket is attached, such as by being bolted, onto a distal end of the horizontal members.

Another type of aerial work platform is known as a scissor lift. A scissor lift includes a mobile base unit with a lifting mechanism extending vertically therefrom. The lifting mechanism includes members connected in a scissor-like manner. A basket is attached onto a distal end of the lifting mechanism. The basket is raised or lowered, as desired, by causing the lifting members to engage each other in a scissor-like manner.

The basket includes guard rails and a control panel for controlling functions such as raising and lowering the basket, rotating the basket (when attached to a boom lift), driving and steering the mobile base unit, and the like. The basket also includes a floor. A foot-operated master switch for the control panel is mounted on the floor. The floor typically is made from an expanded metal grate. Decals are attached to various surfaces of the basket to convey information, cautions, and warnings, and to identify various features. Various hardware and/or tools may be contained in the basket.

However, if a tool, part, workpiece, component, consumable, or other item being used in a maintenance or construction action were dropped, then the dropped item may fall out of the sides of the basket toward the ground. While falling toward the ground, the dropped part may impact items installed in a facility (such as video screens, loudspeakers, seats, and the like), facility structure, facility walls, and the like. Such impacted items and/or structure may become dislodged and may, in turn, fall toward the ground. The dropped part and/or impacted items and/or structure may result in damage to the item, damage to items installed in a facility, damage to facility structure, walls, and/or floor, and/or injury to a person or persons who may be struck by any one or more of such falling items.

### SUMMARY

Disclosed embodiments include shield assemblies for baskets of aerial work platforms, methods of fabricating a shield assembly for a basket of an aerial work platform, and methods of attaching a shield assembly onto a basket of an aerial work platform.

In an illustrative embodiment given by way of non-limiting example, a shield assembly for a basket of an aerial work platform includes a flexible cover configured to be disposed contiguously about interior sides of a basket of an aerial work platform. Attachment devices are attached to the flexible cover and are configured to removably attach the flexible cover to a basket of an aerial work platform. Tensioning members are removably attachable to a bottom portion of the flexible cover.

In another illustrative embodiment given by way of non-limiting example, a non-limiting, illustrative method of fabricating a shield assembly for a basket of an aerial work platform includes: forming a flexible cover configured to be disposed contiguously about interior sides of a basket of an aerial work platform; attaching a plurality of attachment devices to the flexible cover, the plurality of attachment devices being configured to removably attach the flexible cover to a basket of an aerial work platform; and providing a plurality of tensioning members that are removably attachable to a bottom portion of the flexible cover.

In another illustrative embodiment given by way of non-limiting example, a non-limiting, illustrative method of attaching a shield assembly onto a basket of an aerial work platform includes: disposing a flexible cover contiguously about interior sides of a basket of an aerial work platform; removably attaching the flexible cover to a basket of an aerial work platform; and removably attaching a plurality of tensioning members to a bottom portion of the flexible cover.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the text (e.g., claims and/or detailed description) and/or drawings of the present disclosure.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is a perspective view of an illustrative shield assembly attached to a basket of an aerial work platform.

FIG. 2 illustrates details of features of the shield assembly of FIG. 1.

FIG. 3 illustrates details of features of the shield assembly of FIG. 1.

FIG. 4 illustrates details of features of the shield assembly of FIG. 1.

FIG. 5 illustrates features of the shield assembly of FIG. 1 in operation.

The use of the same symbols in different drawings typically indicates similar or identical items unless context dictates otherwise.

### DETAILED DESCRIPTION

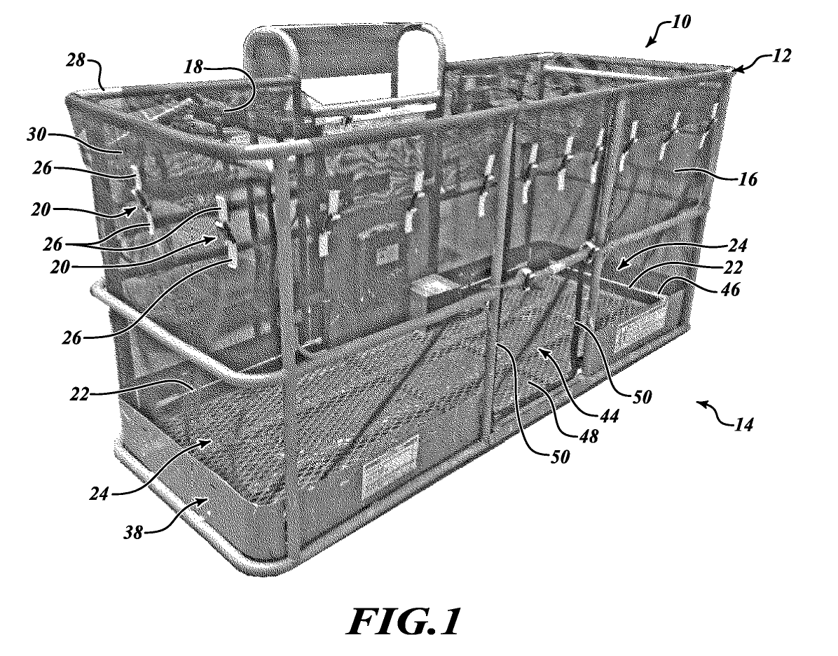

Given by way of non-limiting overview and referring to FIG. 1, an illustrative shield assembly 10 for a basket 12 of an aerial work platform 14 includes a flexible cover 16 configured to be disposed contiguously about interior sides 18 of the basket 12. Attachment devices 20 are attached to the cover 16 and are configured to removably attach the cover 16 to the basket 12. Tensioning members 22 are removably attachable to a bottom portion 24 of the cover 16.

Still by way of overview, in various embodiments the shield assembly 10 is configured for use with an aerial work platform 14 such as a boom lift (also referred to as a “cherry picker”) or a scissor lift. As is known, the aerial work platform 14 may be used for temporary, flexible access purposes such as maintenance and construction work. As such, workers in the basket 12 may perform tasks such as, without limitation, such as among other things performing planned maintenance items, performing repairs, painting, cleaning, and the like. If a tool, part, workpiece, component, consumable, or other item being used in a maintenance or construction action were dropped, then the dropped item may impact the cover 16 and slide down the cover 16 toward the bottom portion 24 of the cover 16. In some instances, a sufficient-enough impact force may detach the bottom portion 24 of the cover 16 from the basket 12. However, the tensioning members 22 help keep the affected portion of the cover 16 from collapsing and help the bottom portion 24 of the cover 16 keep a substantially straight shape along a toe kick 38 of the basket 12, thereby helping to prevent a gap (such as a “v”-shaped gap) from forming in the cover 16 through which a dropped item may fall. In addition, the tensioning member 22 may act as a “floor” member that holds up the dropped item. Thus, the shield assembly 10 may help reduce the likelihood that dropped items may fall out the basket 12 toward the ground. As a result, the shield 10 assembly may, in turn, help reduce the likelihood that dropped items may damage items installed in a facility, damage facility structure, walls, and/or floor, and/or injure a person or persons who may be struck by any one or more of such falling items.

Details will be set forth below by way of illustrative examples and not of limitation.

Still referring to FIG. 1, in various embodiments the cover 16 is a contiguous piece of a flexible fabric, such as without limitation a vinyl coated synthetic webbing. Because the fabric 16 is a contiguous piece of fabric, the entirety of the interior sides 18 of the basket 12 are covered by the cover 16. As a result, there are no open seams in the cover 16 where separate pieces abut each other and through which items could fall.

In various embodiments, the webbing includes a mesh that defines voids. In some non-limiting embodiments, up to about 65% of the webbing defines the voids. In such embodiments, up to about 65% of the mesh is open air. In some other non-limiting embodiments, up to about 70% of the webbing defines the voids. In such embodiments, up to about 70% of the mesh is open air. As a result, in these embodiments wind may pass through the voids, thereby helping to mitigate effects of wind when the shield assembly is attached to the basket 12. Moreover, the presence of the voids helps to increase visibility through the cover 16. It will be appreciated that the mesh may define any percentage of voids as desired. It will also be appreciated that the cover 16 may be made of any fabric as desired for a particular application, such as without limitation solid vinyl, cotton, mesh, solid material, plastic, and the like.

Still referring to FIG. 1, in various embodiments the attachment devices 20 are sewn onto the cover 16. In such embodiments, corresponding pairs of fabric tabs 26 are sewn onto the cover 16. One tab of the pairs of tabs 26 is sewn onto the cover 16 at a selected distance below a top railing 28 of the basket 12. The other tab of the pair of tabs 26 is sewn onto an extension flap 30 of the cover 16. In various embodiments the attachment devices 20 may include paired devices such as buckles, snaps, clips, and/or hook-and-loop fasteners. One of the paired devices is attached to one tab of the pair of tabs 26 and the other paired device is attached to the other tab of the pair of tabs 26. The extension flap 30 is looped from the interior sides 18 around the railing 28 and the paired devices are matingly engaged with each other, thereby attaching the cover 16 to the basket 12.

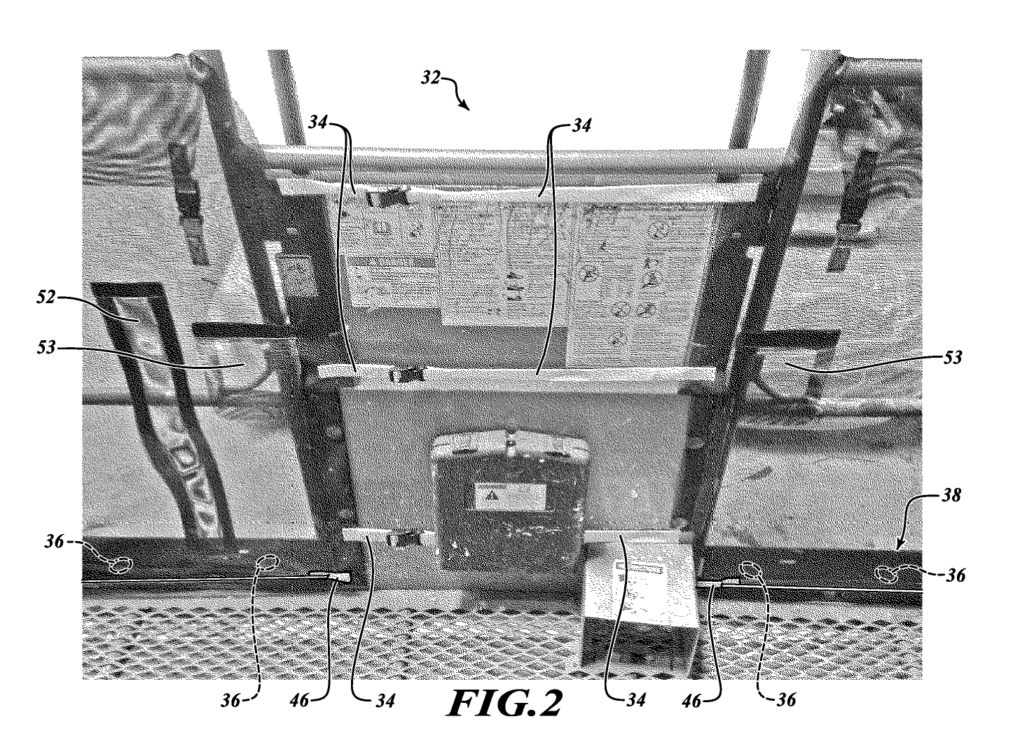

Referring additionally to FIG. 2, in some embodiments the attachment devices 20 adjacent a control panel 32 include straps 34. The straps 34 are attached to the tabs 26 and the paired devices of the attachment devices 20, thereby permitting ends of the cover 16 to be fastened to each other in the vicinity of the control panel 32. Any number of the straps 34 may be provided as desired. It will be appreciated that the greater the number of the straps 34, the greater the integrity of the shape of the cover 16 is maintained. It will also be appreciated that providing one or more of the straps 34 at or near the bottom portion 24 of the cover 16 can help maintain the shape of the cover 16 if an item is dropped and impacts the cover 16.

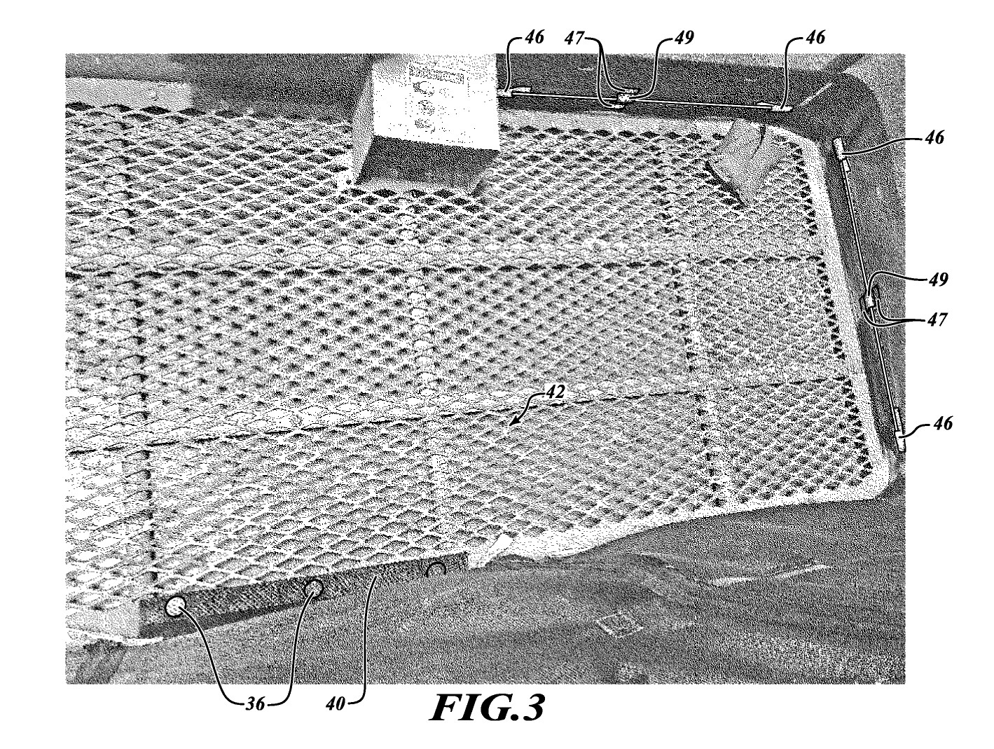

Still referring to FIG. 2, in some embodiments the attachment devices also include magnets 36 (shown in phantom). In such embodiments the magnets 36 are sewn into the cover 16. The magnets 36 are disposed about the bottom portion 24 of the cover 24 such that the magnets 36 can magnetically engage a toe kick 38 of the basket 12, thereby holding the cover 16 onto the toe kick 38. Referring additionally to FIG. 3, in some embodiments some of the magnets 36 may be sewn into an extension flap 40 of the cover 16 that rests on a floor 42 of the basket 16 in the vicinity of a door 44 (FIG. 1) of the basket 12. In such embodiments, the magnets 36 magnetically engage the floor 42 because, as shown in FIG. 1, some baskets 12 provided by various vendors may (or may not) not provide a toe kick in the vicinity of the door 44.

In some other embodiments, the bottom portion 24 of the cover 16 may include a weighted hem. The weighted hem provides weight (in addition to the weight of the shield assembly 10 itself) at the bottom portion 24 around the toe kick 38. The additional weight can help keep the shield assembly 10 gravitationally urged downwardly sufficiently such that the shield assembly 10 may remain in place when attached to the basket 12.

Still referring to FIGS. 1-3, in various embodiments pairs of pocket tabs 46 are attached to the cover 16. In such embodiments an individual member of the tensioning members 22 is insertable into an associated pair of the pocket tabs 46. In such embodiments the tensioning members 22 may include without limitation rods, such as without limitation fiberglass rods. As shown in FIG. 3, in various embodiments one or more tabs 47 are sewn onto the cover 16 between the paired pocket tabs 46. A closure device 49 is attached to the tabs 47. The closure device 49 may include any suitable closure device, such as without limitation buckles, snaps, clips, and/or hook-and-loop fasteners. After the rod is inserted into the pocket tabs 46 the closure device is closed around the rod, thereby holding the rod to the cover 16 at a location (or locations) in addition to the pocket tabs 46. Holding the rod onto the cover 16 with the tabs 47 and the closure devices 49 can contribute to helping keep the affected portion of the cover 16 from collapsing and helping the bottom portion 24 of the cover 16 keep a substantially straight shape along the toe kick 38 of the basket 12, thereby helping to prevent a gap (such as a “v”-shaped gap) from forming in the cover 16 through which a dropped item may fall. It will be appreciated that the length of the rods may be selected as desired for a particular application.

Still referring to FIGS. 1-3, in various embodiments the cover 16 defines an openably closeable door portion 48 that is positionable adjacent the door 44. In such embodiments, a pair of zippers 50 are disposed on the cover 16 and the door portion 48, and the pair of zippers 50 are configured to openably close the door portion 48 with the cover 16. The zippers 50 are unzipped to permit the door 44 to be raised and lowered and are zipped when the door 44 is lowered and will remain lowered (such as for the performance of work).

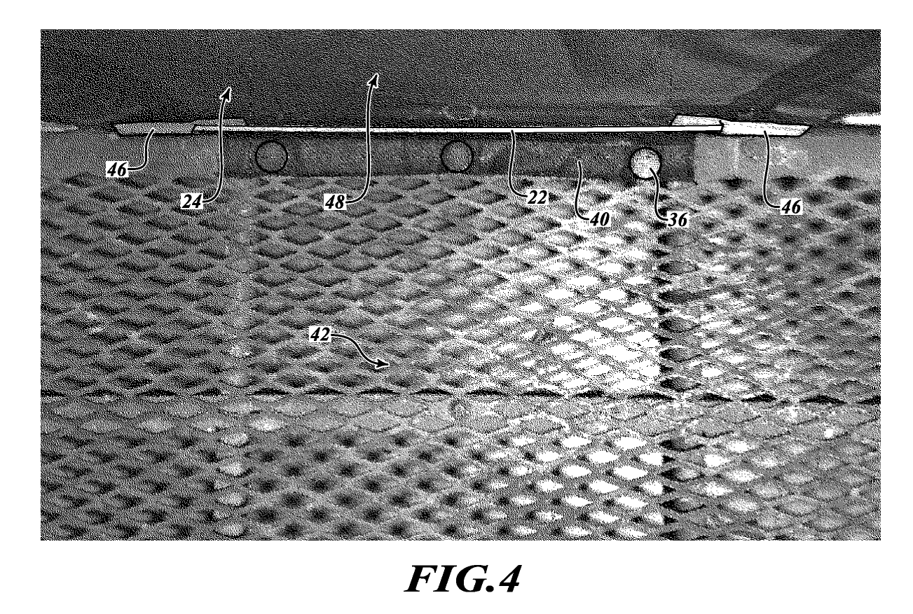

Referring additionally to FIG. 4, in some embodiments the tensioning member 22 that is removably attachable to the bottom portion 24 of the cover 16 proximate the door portion 48 has a length that is longer than a width of the door portion 48. In applications in which the basket 12 does not include the toe kick at the door 44, the tensioning member 22 engages the toe kick 38 adjacent the door 44 and maintains the cover 16 inside the basket 12.

If desired, in various embodiments a pocket 52 (FIG. 2) may be provided on the cover 16. When the pocket 52 is provided, the tensioning members 22 may be stored in the pocket 52. If desired, in various embodiments the cover 16 may define cutouts with flap covers 53 (FIG. 2) that correspond to locations of features such as, without limitation, tie-off points for harnesses, electrical outlets, and the like, and that openably cover and permit access to those features.

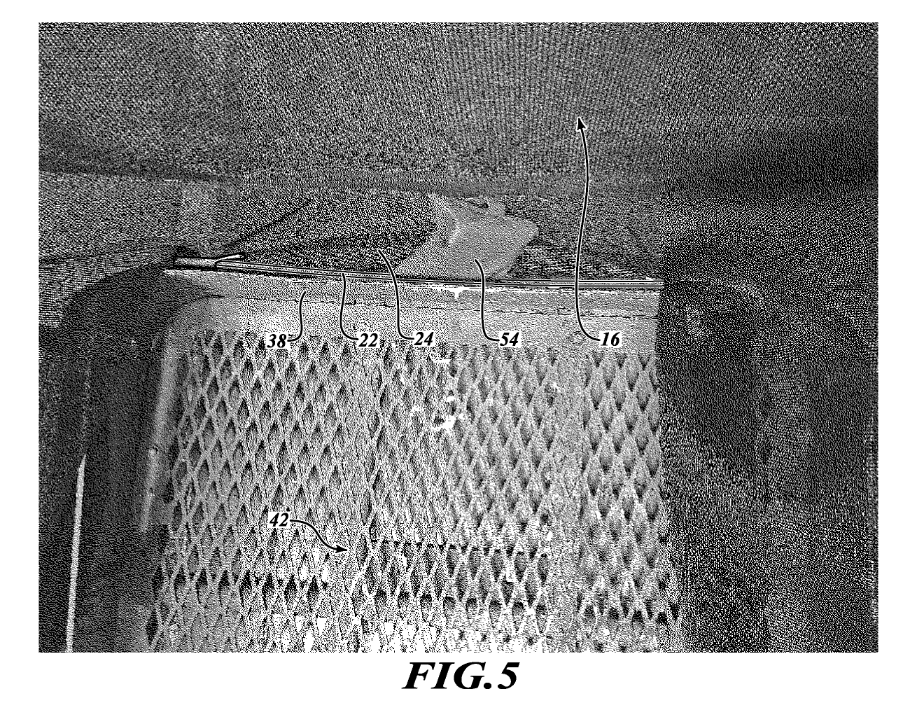

Referring additionally to FIG. 5, embodiments of the shield assembly 10 operate as follows. If a tool, part, workpiece, component, consumable, or other item being used in a maintenance or construction action (collectively referred to as item 54) were dropped, then the dropped item may impact the cover 16 and slide down the cover 16 toward the bottom portion 24 of the cover 16. In some instances and as shown in FIG. 5, a sufficient-enough impact force may detach the bottom portion 24 of the cover 16 from the basket 12. However, the tensioning members 22 help keep the affected portion of the cover 16 from collapsing and help the bottom portion 24 of the cover 16 keep a substantially straight shape along the toe kick 38, thereby helping to prevent a gap (such as a “v”-shaped gap) from forming in the cover 16 through which the dropped item 54 may fall. In addition, the tensioning member 22 may act as a “floor” member that holds up the dropped item 54. Thus, the shield assembly 10 may help reduce the likelihood that dropped items may fall out the basket 12 toward the ground. As a result, the shield 10 assembly may, in turn, help reduce the likelihood that dropped items may damage items installed in a facility, damage facility structure, walls, and/or floor, and/or injure a person or persons who may be struck by any one or more of such falling items.

It will be appreciated that various baskets 12 made by different manufactures may have different shapes, sizes, and features. For example, the door 44 may be located in the longer side of the basket 12 or may be located in one of the shorter sides of the basket 12. Further, the door 44 may be a slide-up bar design or may be a swinging-open design. Also, the toe kick 38 may have voids (such as in the vicinity of the door 44) or may be continuous. Further, the number and placement of features, such as tie-off points for harnesses, electrical outlets, and the like, may vary to correspond to the design and shape of the basket 12. In view of such variations and other variations, it will be appreciated that embodiments of the shield assemblyl0 are designed and fabricated appropriately to fit applications for various baskets 12 of various designs by various manufacturers.

Now that various embodiments of the shield assembly 10 have been described, illustrative methods of their fabrication and attachment to a basket of an aerial work platform will be described by way of nonlimiting examples.

An illustrative method of fabricating a shield assembly for a basket of an aerial work platform is set forth below. In various embodiments, a flexible cover configured to be disposed contiguously about interior sides of a basket of an aerial work platform is formed. A plurality of attachment devices are attached to the flexible cover, the plurality of attachment devices being configured to removably attach the flexible cover to a basket of an aerial work platform. A plurality of tensioning members that are removably attachable to a bottom portion of the flexible cover are provided.

In some embodiments, forming a flexible cover configured to be disposed contiguously about interior sides of a basket of an aerial work platform may include defining in the flexible cover an openably closeable door portion positionable adjacent a door of a basket of an aerial work platform. In some embodiments, defining in the flexible cover an openably closeable door portion positionable adjacent a door of a basket of an aerial work platform may include disposing a pair of zippers on the flexible cover and the door portion, the pair of zippers being configured to openably close the door portion with the flexible cover.

In some embodiments, attaching a plurality of attachment devices to the flexible cover may include sewing the plurality of attachment devices onto the flexible cover. In some embodiments, sewing the plurality of attachment devices onto the flexible cover may include sewing a plurality of magnets into the flexible cover.

In various embodiments, a plurality of pairs of pocket tabs are attached to the flexible cover. In some embodiments, attaching a plurality of pairs of pocket tabs to the flexible cover may include sewing the plurality of pairs of pocket tabs onto the flexible cover.

An illustrative method of attaching a shield assembly onto a basket of an aerial work platform is set forth below. In various embodiments, a flexible cover is disposed contiguously about interior sides of a basket of an aerial work platform. The flexible cover is removably attached to a basket of an aerial work platform. A plurality of tensioning members are removably attached to a bottom portion of the flexible cover.

In some embodiments, removably attaching the flexible cover to a basket of an aerial work platform may include removably attaching the flexible cover to a basket of an aerial work platform with a plurality of attachment devices configured to removably attach the flexible cover to a basket of an aerial work platform. In some embodiments, removably attaching the flexible cover to a basket of an aerial work platform with a plurality of attachment devices configured to removably attach the flexible cover to a basket of an aerial work platform may include removably attaching the flexible cover to a basket of an aerial work platform with a plurality of magnets.

In some embodiments, removably attaching a plurality of tensioning members to a bottom portion of the flexible cover may include inserting an individual member of the plurality of tensioning members into an associated pair of a plurality of pairs of pocket tabs that are attached to the flexible cover.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While a number of illustrative embodiments and aspects have been illustrated and discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

What is claimed is:

1. A shield assembly for a basket of an aerial work platform, the shield assembly comprising:
a flexible cover configured to be disposed contiguously about interior sides of a basket of an aerial work platform;
a plurality of attachment devices attached to the flexible cover and configured to removably attach the flexible cover to a basket of an aerial work platform; and
a plurality of tensioning members removably attachable to a bottom portion of the flexible cover.

2. The shield assembly of claim 1, wherein the flexible cover is made of a vinyl coated synthetic webbing.

3. The shield assembly of claim 2, wherein the webbing includes a mesh that defines a plurality of voids.

4. The shield assembly of claim 1, wherein the plurality of attachment devices are sewn onto the flexible cover.

5. The shield assembly of claim 1, wherein the plurality of attachment devices include at least one of buckles, snaps, clips, and hook-and-loop fasteners.

6. The shield assembly of claim 5, wherein the plurality of attachment devices further include a plurality of magnets.

7. The shield assembly of claim 6, wherein the plurality of magnets are sewn into the flexible cover.

8. The shield assembly of claim 1, further comprising:
a plurality of pairs of pocket tabs attached to the flexible cover, an individual member of the plurality of tensioning members being insertable into an associated pair of the plurality of pairs of pocket tabs.

9. The shield assembly of claim 8, further comprising:
at least one pair of tabs attached to the flexible cover between at least one pair of pocket tabs; and
a closure device attached to the tabs, the closure device being configured to close around the tensioning member such that the tensioning member is held against the flexible cover.

10. The shield assembly of claim 1, wherein the plurality of tensioning members include a plurality of rods.

11. A method of fabricating a shield assembly for a basket of an aerial work platform, the method comprising:
forming a flexible cover configured to be disposed contiguously about interior sides of a basket of an aerial work platform;
attaching a plurality of attachment devices to the flexible cover, the plurality of attachment devices being configured to removably attach the flexible cover to a basket of an aerial work platform; and
providing a plurality of tensioning members that are removably attachable to a bottom portion of the flexible cover.

12. The method of claim 11, wherein forming a flexible cover configured to be disposed contiguously about interior sides of a basket of an aerial work platform includes defining in the flexible cover an openably closeable door portion positionable adjacent a door of a basket of an aerial work platform.

13. The method of claim 12, wherein defining in the flexible cover an openably closeable door portion positionable adjacent a door of a basket of an aerial work platform includes disposing a pair of zippers on the flexible cover and the door portion, the pair of zippers being configured to openably close the door portion with the flexible cover.

14. The method of claim 11, wherein attaching a plurality of attachment devices to the flexible cover includes sewing the plurality of attachment devices onto the flexible cover.

15. The method of claim 14, wherein sewing the plurality of attachment devices onto the flexible cover includes sewing a plurality of magnets into the flexible cover.

16. The method of claim 11, further comprising:
attaching a plurality of pairs of pocket tabs to the flexible cover.

17. The method of claim 16, wherein attaching a plurality of pairs of pocket tabs to the flexible cover includes sewing the plurality of pairs of pocket tabs onto the flexible cover.

18. The method of claim 16, further comprising:
attaching at least one pair of tabs to the flexible cover between at least one pair of pocket tabs, the tabs having a closure device attached thereto, the closure device being configured to close around the tensioning member such that the tensioning member is held against the flexible cover.

19. A method of attaching a shield assembly onto a basket of an aerial work platform, the method comprising:
disposing a flexible cover contiguously about interior sides of a basket of an aerial work platform;
removably attaching the flexible cover to a basket of an aerial work platform; and
removably attaching a plurality of tensioning members to a bottom portion of the flexible cover.

20. The method of claim 19, wherein removably attaching the flexible cover to a basket of an aerial work platform includes removably attaching the flexible cover to a basket of an aerial work platform with a plurality of attachment devices configured to removably attach the flexible cover to a basket of an aerial work platform.

21. The method of claim 19, wherein removably attaching the flexible cover to a basket of an aerial work platform with a plurality of attachment devices configured to removably attach the flexible cover to a basket of an aerial work platform includes removably attaching the flexible cover to a basket of an aerial work platform with a plurality of magnets.

22. The method of claim 19, wherein removably attaching a plurality of tensioning members to a bottom portion of the flexible cover includes inserting an individual member of the plurality of tensioning members into an associated pair of a plurality of pairs of pocket tabs that are attached to the flexible cover.

23. The method of claim 22, further comprising:
closing a closure device around the tensioning member such that the tensioning member is held against the flexible cover.
